(19) United States
(12) Patent Application Publication
(10) Pub. No.: US 2023/0336470 A1
(43) Pub. Date: Oct. 19, 2023

(54) METHODS AND SYSTEMS FOR PREDICTING SUDDEN CHANGES IN DATACENTER NETWORKS

(71) Applicants: Ali MUNIR, Kitchener (CA); Amir BANIAMERIAN, Montreal (CA); Mahmoud Mohamed BAHNASY, Waterloo (CA); Seyed Hossein MORTAZAVI, North York (CA); Yashar GANJALI, North York (CA)

(72) Inventors: Ali MUNIR, Kitchener (CA); Amir BANIAMERIAN, Montreal (CA); Mahmoud Mohamed BAHNASY, Waterloo (CA); Seyed Hossein MORTAZAVI, North York (CA); Yashar GANJALI, North York (CA)

(21) Appl. No.: 17/721,273

(22) Filed: Apr. 14, 2022

(51) Int. Cl. H04L 45/42; H04L 45/02; H04L 43/062; H04L 43/106; G06K 9/62; G06N 20/00

(52) U.S. Cl. CPC H04L 45/42; H04L 45/02; H04L 43/062; H04L 43/106; G06K 9/6256; G06N 20/00

(57) ABSTRACT

The present disclosure describes methods and systems for proactively managing a distributed computer network based on learned relationships between state changes and network events. During an initial identification phase, information representing state changes occurring at host nodes, and network events occurring at network nodes, is collected and processed to generate a database of event probability signatures, each event probability signature indicating a respective probability that a specified event type will occur at a specified network node given a specified type of state change at one of the hosts. During a subsequent action phase, a smart network engine can interact with software drivers installed on each host node to actively monitor for state changes, and when a state change is detected, compare the type of state change with the types of state changes specified in the plurality of event probability signatures to select a matching event probability signature. Using the selected matching event probability signature, a controller can proactively mitigate future network events.

### FIELD

The present disclosure is related to the field of distributed computer networks, particularly to the management of datacenter networks using methods and systems for monitoring and correlating state changes and network events.

### BACKGROUND

Datacenters have increasingly become essential for many businesses and enterprises requiring the ability to organize, process, store and transfer large volumes of data. Datacenters include a pool of distributed resources which are interconnected by a datacenter network. Often, while these distributed resources are working together to run applications or communicate across the network, the components of the network may experience a sudden change in state that negatively impacts network performance. For example, when an application finishes a data processing task and switches to a communication task, for example, transferring the processed data over the network to a single destination, the sudden increase in congestion over the network may result in a network event, for example, a packet drop. These sudden changes in the state of network components and resulting logged network events are often related, however existing distributed computer network management approaches do not fully leverage this relationship between application state changes and network events to develop mechanisms to improve quality of experience (QoE) or quality of service (QoS).

Accordingly, it would be desirable to provide a way to improve the QoE and QoS of distributed computer networks by enabling network controllers to proactively manage a datacenter network based on relationships between sudden changes in the state of datacenter network components and logged network events.

### SUMMARY

In various examples described herein, methods and systems are provided to proactively manage a distributed computer network based on learned relationships between state changes and network events. During an initial identification phase, information representing state changes occurring at host nodes, and network events occurring at network nodes, is collected and processed to generate a database of event probability signatures, each event probability signature indicating a respective probability that a specified event type will occur at a specified network node given a specified type of state change at one of the hosts. During a subsequent action phase, a smart network engine can interact with software drivers installed on each host node to actively monitor for state changes, and when a state change is detected, compare the type of state change with the types of state changes specified in the plurality of event probability signatures to select a matching event probability signature. Using the selected matching event probability signature, a controller can proactively mitigate future network events.

In some examples, the present disclosure provides the technical advantage that a smart network management system can predict whether an event will occur in the network, in some cases, several time units (RTT) earlier even before they happen, and enables a network controller to initiate a preventative action to mitigate negative impacts of the event.

In some examples, the present disclosure provides the technical advantage that the smart network management system learns relationships between tags and events occurring within a distributed network, and leverages this information to improve QoS and QoE.

In some examples, the present disclosure provides the technical advantage that leveraging tags in a proactive network management system requires low overhead, as tags are already generated by network components.

In some aspects, the present disclosure describes a method of managing a distributed datacenter network that comprises a plurality of host nodes that each host one or more applications, and a network that interconnects the host nodes and comprises a plurality of network nodes for routing data within the network. The method includes: storing, within a database, a plurality of event probability signatures, each event probability signature indicating a respective probability that a specified event type will occur at a specified network node given a specified type of state change at one of the host nodes; obtaining a state change record that indicates a type of state change that has occurred at one of the host nodes and a timestamp of the state change; comparing the type of state change indicated in the state change record with the types of state changes specified in the plurality of event probability signatures to select a matching event probability signature; and providing the respective probability that a future event of the specified event type will occur at the specified network node indicated in the selected matching event probability signature to a controller that is configured to control one or more of the network nodes or the host nodes.

In the preceding example aspect of the method, the method further comprises: generating the plurality of event probability signatures by: obtaining a plurality of state change records representing a plurality of state changes occurring at one or more of the host nodes; obtaining a plurality of event records representing a plurality of network events occurring at one or more of the network nodes; and correlating the plurality of state change records and the plurality of event records to generate the one or more event probability signatures, the one or more event probability signatures describing a learned relationship between one or more state change types and respective event types.

In the preceding example aspect of the method, wherein correlating the plurality of state change records and the plurality of event records comprises: grouping the plurality of state change records and the plurality of event records into one or more groups based a state change location and an event location as well as any previously learned relationship information, using a temporal mining algorithm; clustering the groups of state change records and event records based on a timestamp of each state change record and a timestamp of each event record in each group, the timestamp of each state change record and the timestamp of each event record indicating a position of a respective state change type and a position of a respective event type within a certain time window; and estimating, for each cluster, one or more probabilities that a specified event type will occur at a specified network node given a specified type of state change at one of the host nodes, based on one or more elements in each cluster.

In some example aspects of the method, wherein correlating the plurality of state change records and the plurality of event records is performed by a machine learning model that has been trained to identify the respective probability that a specified event type will occur at a specified network node given a specified type of state change at one of the host nodes.

In some example aspects of the method, wherein correlating the plurality of state change records and the plurality of event records is performed by a rule based statistical model that has been trained to identify the respective probability that a specified event type will occur at a specified network node given a specified type of state change at one of the host nodes.

In some example aspects of the method, wherein obtaining a plurality of state change records comprises: obtaining information describing one or more state changes at one or more specified host nodes; and formatting the state change information for each state change to generate one or more state change records, each state change record comprising: a timestamp that indicates when the state change occurred at one of the specified host nodes; a location identifier that indicates the one of the specified host nodes where the state change occurred; and a state change type identifying the type of the state change that occurred at the one of the specified host nodes.

In some example aspects of the method, wherein the state change record further comprises a value that indicates a property associated with the state change type.

In some example aspects of the method, wherein the state change record can be an application-level state change record or a host-level state change record.

In some example aspects of the method, wherein the application level state change record identifies one of: an application type; an application deployment; an application configuration; a state of an application response/request; a number of repetitions; an application start and end time; or a direction.

In some example aspects of the method, wherein the host-level state change record identifies one of: a state of hardware resources while an application is running on a host; a socket level; a state of data transfer into a host; or a state of data transfer out a port.

In some example aspects of the method, wherein obtaining a plurality of event records comprises: receiving information about one or more network events occurring at one or more specified network nodes; and formatting the network event information for each network event to generate one or more event records, each event record comprising: a timestamp that indicates when the network event occurred at one of the specified network nodes; a location identifier that indicates the one of the specified network nodes where the network event occurred; and an event type identifying the type of the network event that occurred at the one of the specified network nodes.

In some example aspects of the method, wherein the event record further comprises a value that indicates a property associated with the event type.

In some aspects, the present disclosure describes a method for managing a distributed computer network that comprises a plurality of host nodes that each host one or more applications, and a network that interconnects the host nodes and comprises a plurality of network nodes. The method comprises: generating a plurality of event probability signatures, each event probability signature indicating a respective probability that a specified event type will occur at a specified network node given a specified type of state change at one of the host nodes, the plurality of event probability signatures being generated by: obtaining a plurality of state change records representing a plurality of state changes occurring at one or more of the host nodes; obtaining a plurality of event records representing a plurality of network events occurring at one or more of the network nodes; and correlating the plurality of state change records and the plurality of event records to generate one or more event probability signatures, the one or more event probability signatures describing a learned relationship between one or more state change types and respective event types.

In the preceding example aspect of the method, wherein each event probability signature comprises: a state change type identifying a specified type of the respective state change that occurred at a specified host node of the one or more host nodes; an event type identifying a specified type of the respective network event that occurred at a specified network node of the one or more network nodes; a location identifier that indicates the one of the specified network nodes where the respective network event occurred; a time delay indicating a pre-determined period of time following the specified state change type occurring, during which a predicted event corresponding to the specified event type may occur; and a probability that the specified event type will occur at the specified network node of the one or more network nodes within the pre-determined period of time following the occurrence of the specified state change type, given the specified state change type occurs at the specified host node of the one or more host nodes.

In some example aspects of the method, wherein executing a smart network action comprises: generating a rule or policy corresponding to a specified state change type, based on the event probability signature; installing the rule or policy at one of the host nodes or one of the network nodes; setting an expiration time defining a length of time for which the rule or policy installed at the one of the host nodes or the one of the network nodes can be executed; performing the action specified in the rule or policy installed at the one of the host nodes or the one of the network nodes if a state change type matching the specified state change type occurs at the one of the host nodes or the one of the network nodes; and deleting the rule or policy from the one of the host nodes or the one of the network nodes once the expiration time has been reached.

In some aspects, the present disclosure describes a system for managing a distributed computer network. The system comprises: a plurality of host nodes that each host one or more applications; a network that interconnects the host nodes and comprises a plurality of network nodes; a processing device on one of the host nodes; and a memory in communication with the processing device, the memory storing machine-executable instructions which, when executed by the processing device, cause the system to: store, within a database, a plurality of event probability signatures, each event probability signature indicating a respective probability that a specified event type will occur at a specified network node given a specified type of state change at one of the host nodes obtain a state change record that indicates a type of state change that has occurred at one of the host nodes and a timestamp of the state change; compare the type of state change indicated in the state change record with the types of state changes specified in the plurality of event probability signatures to select a matching event probability signature; and provide the respective probability that a future event of the specified event type will occur at the specified network node indicated in the selected matching event probability signature to a controller that is configured to control one or more of the network nodes or the host nodes.

In the preceding example aspect of the system, wherein the machine-executable instructions, when executed by the one or more processing devices, further cause the system to: generate the plurality of event probability signatures by: obtaining a plurality of state change records representing a plurality of state changes occurring at one or more of the host nodes; obtaining a plurality of event records representing a plurality of network events occurring at one or more of the network nodes; and correlating the plurality of state change records and the plurality of event records to generate the one or more event probability signatures, the one or more event probability signatures describing a learned relationship between one or more state change types and respective event types.

In some example aspects of the system, wherein in correlating the plurality of state change records and the plurality of event records, the machine-executable instructions, when executed by the one or more processing devices, further cause the system to: group the plurality of state change records and the plurality of event records into one or more groups based a state change location and an event location as well as any previously learned relationship information, using a temporal mining algorithm; cluster the groups of state change records and event records based on a timestamp of each state change record and a timestamp of each event record in each group, the timestamp of each state change record and the timestamp of each event record indicating a position of a respective state change type and a position of a respective event type within a certain time window; and estimate, for each cluster, one or more probabilities that a specified event type will occur at a specified network node given a specified type of state change at one of the host nodes, based on one or more elements in each cluster.

In some example aspects of the system, wherein correlating the plurality of state change records and the plurality of event records is performed by a machine learning model that has been trained to identify the respective probability that a specified event type will occur at a specified network node given a specified type of state change at one of the host nodes.

In some example aspects of the system, wherein correlating the plurality of state change records and the plurality of event records is performed by a rule based statistical model that has been trained to identify the respective probability that a specified event type will occur at a specified network node given a specified type of state change at one of the host nodes.

### BRIEF DESCRIPTION OF THE DRAWINGS

Reference will now be made, by way of example, to the accompanying drawings which show example embodiments of the present application, and in which:

FIG. 1 is a block diagram illustrating an example simplified system in which examples disclosed herein may be implemented.

FIG. 2 is a block diagram of an example server that may be used to implement examples described herein;

FIG. 3 is a block diagram of an example smart network management system that may be used to implement examples described herein;

FIG. 4 is a block diagram of an example correlation engine of the smart network engine, in accordance with examples described herein;

FIG. 5A is a schematic diagram illustrating an example state change record format, in accordance with examples described herein;

FIG. 5B is a schematic diagram illustrating an example event record format, in accordance with examples described herein;

FIG. 5C is a schematic diagram illustrating an example event probability signature format, in accordance with examples described herein;

FIG. 5D is a block diagram illustrating example state change records, event records and event probability signatures, in accordance with examples described herein;

FIG. 6A is a block diagram of an example host-level smart network driver, in accordance with examples described herein;

FIG. 6B is a block diagram of an example network-level smart network driver, in accordance with examples described herein; and

FIG. 7 is a flowchart showing operations of a method for proactively managing a distributed computer network, in accordance with example implementations described herein.

Similar reference numerals may have been used in different figures to denote similar components.

### DESCRIPTION OF EXAMPLE EMBODIMENTS

The following describes example technical solutions of this disclosure with reference to accompanying figures. Similar reference numerals may have been used in different figures to denote similar components.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

The present disclosure describes systems, methods, and processor-readable media for proactively managing a distributed computer network based on learned relationships between state changes and network events. During an initial identification phase, information representing state changes occurring at host nodes, and network events occurring at network nodes, is collected and processed to generate a database of event probability signatures, each event probability signature indicating a respective probability that a specified event type will occur at a specified network node given a specified type of state change at one of the hosts. During a subsequent action phase, a smart network engine can interact with software drivers installed on each host node to actively monitor for state changes, and when a state change is detected, compare the type of state change with the types of state changes specified in the plurality of event probability signatures to select a matching event probability signature. Using the selected matching event probability signature, a controller can proactively mitigate future network events.

To assist in understanding the present disclosure, some existing techniques for network management based on integrating applications and networks are now discussed.

Current network management tools have a limited picture of the sources of changes in state among network components, partially because of a lack of interaction between the various components. For example, there may be a limited ability to associate changes in one component with other conditions in the network, for example, a limited ability to associate changes in one network component with changes in another. For example, applications can not inform other network elements about state changes and as a result, the network is unaware of an application's intended next steps, for example, when an application plans to send data across the network or how much data an application plans to send across the network. In other situations, limitations in network management may be due to an application being unaware of the current state of the network, for example, if the network is congested. In many cases, network management is reactive. With limited ability to detect and adjust to sudden changes in the state of networks and applications, it is often too late to implement proactive management techniques. For example, reactive solutions detect changes in an application when the network has already been impacted, and act to remedy the network event after it has occurred. For example, TCP congestion management approaches use packet loss as an indicator, and Bottleneck Bandwidth and Round-trip propagation time (BBR) uses a delay signal as an indicator. These approaches are remedial to correct for a network event, such as network congestion while attempting to avoid more congestion in the future.

Some approaches to address the above limitations have focused on improving the interface between network components and applications. One example solution has been proposed, for example, by Guo, Dong, Shuhe Wang, and Y. Richard Yang, “Socker: Network-application Co-programming with Socket Tracing,” Proceedings of the ACM SIGCOMM 2021 Workshop on Network-Application Integration, 2021, the entirety of which is hereby incorporated by reference. Another example solution has been proposed, for example, by Schmidt, Philipp S., et al. “Socket intents: Leveraging application awareness for multi-access connectivity,” Proceedings of the ninth ACM conference on Emerging networking experiments and technologies, 2013, the entirety of which is hereby incorporated by reference. In both of these references, improved sharing of information between applications and networks is proposed at the socket layer, however the proposed frameworks have very limited functionality and are not capable of exchanging information related to state changes in the network or in applications.

The present disclosure describes examples that addresses some or all of the above drawbacks of existing techniques for proactive distributed computer network management.

To assist in understanding the present disclosure, the following describes some concepts relevant to distributed computer networks and network management, along with some relevant terminology that may be related to examples disclosed herein.

As used herein, the term “computer network” refers to a set of computing devices or electronic communication devices in communication with one another using one or more standardized digital communication protocols. The communications may take place over any type of wired or wireless digital communication link, or combinations thereof. The devices may be routers, switches, computers such as servers or personal computers, mobile devices such as smartphones, Internet of Things (IoT) devices, or any other devices capable of transmitting, receiving, and/or routing communications via a digital communication network.

In the present disclosure, a “node” can be defined as any device participating in a distributed computer network. Nodes may include network devices such as hosts, switches, routers etc. In the present disclosure, nodes may be classified as “network nodes” and “host nodes.” A “network node” can refer to an intermediate network element that routes data through network paths between network devices such as host nodes. Examples of network nodes include a switch or a router. A “host node”, “host” or “end host” can refer to a computer or device or virtual machine that communicates with other hosts, to send or receive data, services or applications. For example, a server is a type of host that hosts one or more applications to provide services to other hosts. While every host is considered to be a node, not every node is a host. An application can refer to a set of operations that are performed by a computer system such as a host node in response to asset of application-specific software instructions that are executed by one or more processors of the computer system.

In the present disclosure, a “tag” can be defined as a signal or a metadata label that is generated by an application or host node that represents a change in the current state of the application or host node. Tags are generated by applications or hosts for purposes specific to an application or network function and provide information that can be leveraged for additional purposes, for example, for smart network management. In some examples, these signals may be piggybacked on packets communicated through normal channels or alternatively may be communicated through a separate control channel. Tags are custom designed for each application, and therefore can take many formats. Tags are independent of other tags, and typically do not contain information about application content itself, to maximize data privacy. In this disclosure, a tag that is generated by an application can be referred to as an “application-level tag”, and a tag that is generated by a host or a network element interacting with a host, for example, a switch or a router, can be referred to as a “host-level tag”. An example of an application-level tag may be a signal triggered by a distributed machine learning (DML) application when it initiates an allreduce operation to gather data from multiple distributed nodes. An example of a host-level tag may be a signal associated with the host level congestion window (CWND) that indicates upcoming data flow.

In the present disclosure, a “state change record” can refer to a record that is generated in response to the occurrence of a tag, indicating that a state change that has occurred at one of the host nodes in a distributed computer network. In some examples, a state change record follows a specific format and also includes information about the time that a state change occurred, a local identifier that indicates a location where the tag occurred in the network, an identifier that specifies the type of the state change and optionally, a parameter that is relevant to the associated state change.

In the present disclosure, an “event” or a “network event” can be defined as an occurrence at a network node in the network. In the context of network management, a network event may include a problematic occurrence within the network that negatively impacts the quality of service (QoS) or quality of experience (QoE) associated with using the network. Examples of network events may be packet drops, bursts, or instances of network under or over utilization that is logged by the network. In many cases, network events are automatically logged by the network in order to be stored in a network log.

In the present disclosure, an “event record” can be defined as a record of a network event that has been formatted into a specified format in order to be used by the smart network management system 300. In some examples, an event record follows a specific format and also includes information about the time that an event occurred, a local identifier that indicates a location where the event occurred in the network and optionally, a parameter that is relevant to the associated event.

In the present disclosure, an “agent” or a “software agent” can be defined as a computer program that when invoked, acts on behalf of a user or an application, for example, to interface between nodes of a computer network and complete a specified task.

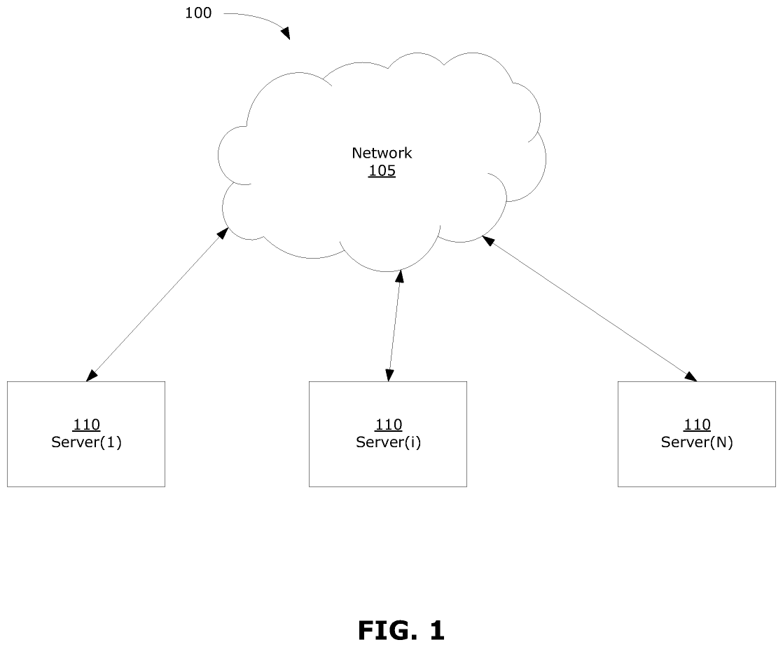

To assist in understanding the present disclosure, FIGS. 1-3 are first discussed.

FIG. 1 illustrates an example system 100 in which examples disclosed herein may be implemented. The system 100 has been simplified in this example for ease of understanding; generally, there may be more entities and components in the system 100 than that shown in FIG. 1. The system 100 may be a datacenter for data processing, storage and communications and may include a network 105. The network 105 may be any form of network (e.g., an intranet, the Internet, a P2P network, a WAN and/or a LAN). The system 100 includes a plurality of host nodes, for example, servers 110, each of which communicates with other hosts to send or receive data, services or applications. For generality, there may be N servers 110 (N being any integer larger than 1). The network 105 may include a plurality of network nodes 106, for example, routers and switches that transport traffic between the servers 110 and external clients. For generality, there may be n network nodes 106 (n being any integer larger than 1) in the network 105. Although not shown in FIG. 1, communications between servers 110, for example server 110(1) and other servers 110(i) . . . 110(N) may also be over the network 105 or another network (which may be private or public), or may be over wired connections. The term “server”, as used herein, is not intended to be limited to a single hardware device: the server 110 may include a server device, a distributed computing system, a virtual machine running on an infrastructure of a datacenter, or infrastructure (e.g., virtual machines) provided as a service by a cloud service provider, among other possibilities. Generally, the server 110 may be implemented using any suitable combination of hardware and software, and may be embodied as a single physical apparatus (e.g., a server device) or as a plurality of physical apparatuses (e.g., multiple machines sharing pooled resources such as in the case of a cloud service provider).

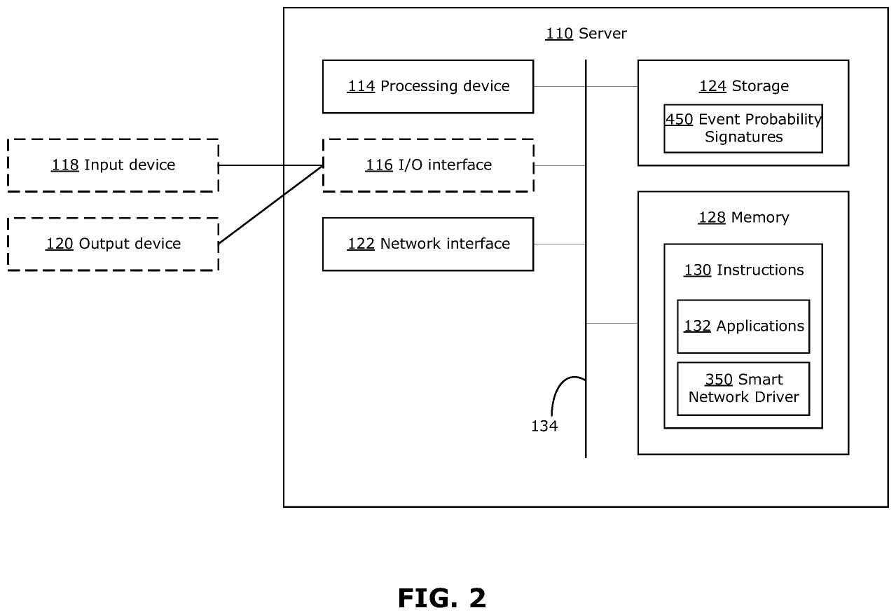

FIG. 2 is a block diagram illustrating a simplified example implementation of the server 110. Other examples suitable for implementing embodiments described in the present disclosure may be used, which may include components different from those discussed below. Although FIG. 2 shows a single instance of each component, there may be multiple instances of each component in the server 110.

The server 110 may include one or more processing devices 114, such as a processor, a microprocessor, a digital signal processor, an application-specific integrated circuit (ASIC), a field-programmable gate array (FPGA), a dedicated logic circuitry, a dedicated artificial intelligence processor unit, or combinations thereof. The server 110 may also include one or more optional input/output (I/O) interfaces 116, which may enable interfacing with one or more optional input devices 118 and/or optional output devices 120.

In the example shown, the input device(s) 118 (e.g., a keyboard, a mouse, a microphone, a touchscreen, and/or a keypad) and output device(s) 120 (e.g., a display, a speaker and/or a printer) are shown as optional and external to the server 110. In other examples, there may not be any input device(s) 118 and output device(s) 120, in which case the I/O interface(s) 116 may not be needed.

The server 110 may include one or more network interfaces 122 for wired or wireless communication with the network 105, or another entity or node in the system 100. The network interface(s) 122 may include wired links (e.g., Ethernet cable) and/or wireless links (e.g., one or more antennas) for intra-network and/or inter-network communications.

The server 110 may also include one or more storage units 124, which may include a mass storage unit such as a solid state drive, a hard disk drive, a magnetic disk drive and/or an optical disk drive. The storage unit(s) 124 may store a plurality of event probability signatures 450, within one or more local databases, for example, a smart network database 460 as discussed further below.

The server 110 may include one or more memories 128, which may include a volatile or non-volatile memory (e.g., a flash memory, a random access memory (RAM), and/or a read-only memory (ROM)). The non-transitory memory(ies) 128 may store instructions for execution by the processing device(s) 114, such as to carry out examples described in the present disclosure. The memory(ies) 128 may include other software instructions, such as for implementing an operating system and other applications/functions. In some examples, the memory(ies) 128 may include software instructions 130 for execution by the processing device 114 to run one or more applications 132. In some examples, the memory(ies) 128 may also include software instructions 130 for execution by the processing device 114 to run a smart network driver 350, as discussed further below. In some examples, the server 110 may additionally or alternatively execute instructions from an external memory (e.g., an external drive in wired or wireless communication with the server 110) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Each server 110 can run a host-level smart network driver 350 (e.g. 350a-N respectively) to operate the smart network management system 300 using a local database storing event probability signatures. For the purposes of the present disclosure, running a smart network driver at a server 110 means executing computer-readable instructions of a driver software to process state change records 440 and event records 445 and communicate with the smart network engine 310. For generality, there may be N host nodes, for example, servers 110 (N being any integer larger than 1) and hence N local databases storing event probability signatures. The local databases are typically unique and distinct from each other, and it may not be possible to infer the characteristics or distribution of any one local dataset based on any other local dataset.

The server 110 may also include a bus 134 providing communication among components of the server 110, including those components discussed above. The bus 134 may be any suitable bus architecture including, for example, a memory bus, a peripheral bus or a video bus.

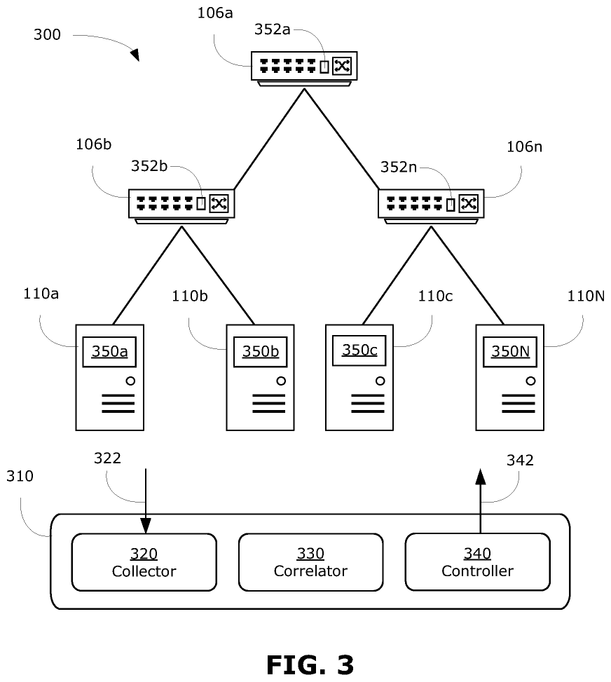

FIG. 3 is a block diagram illustrating the system components of a smart network management system 300. A smart network engine 310 may be configured to interface with a components of a distributed computer network, in order to implement the smart network management system 300. A distributed computer network may be arranged as a collection of distributed nodes, for example, each node being a network component such as a server, a router, a switch etc. configured to communicate over the network. In some examples, the nodes in the distributed computer network may be grouped into network nodes, for example, switches 106a . . . 106n and host nodes, for example, servers 110a . . . 110N. In some examples, switches 106a . . . 106n may be routers. The smart network engine 310 may be located at an end host within the distributed computer network and may be configured to interface with each node. In this way, the smart network engine 310 may be considered to be logistically centralized. In some examples, the smart network engine 310 may include a collector 320, to collect state information 322 on the current state or changes in the state of each node. For example, state information 322 may include information associated with tags generated by the nodes of the distributed computer network and events logged by the network. In some examples, the smart network engine 310 may also include a correlator 330 to correlate the state information 322 in order to help define rules and policies 342 to improve the management of the network. The smart network engine 310 may also include a controller 340 to proactively manage the network by implementing the defined rules and policies 342.

In some examples, a software driver may be installed at each node and may be configured to facilitate communication between each node and the smart network engine 310. The software driver may be a host-level smart network driver 350 and may run on a host node (e.g. a server 110) to monitor changes in the state of the host or the smart network driver may be a network-level smart network driver 352 and may run on a network node (e.g. a switch 106) to monitor changes in the state of the network. In some embodiments, for example, communication between the software drivers and the smart network engine 310 may be implemented using ZeroMQ and JSON. In other embodiments, communication between the software drivers and the smart network engine 310 may be implemented using other methods, for example, an OpenFlow controller, among others. In some examples, the software driver may also be configured to interact in real-time with the controller 340 to install different rules or policies 342 on the network to improve network performance.

In some examples, the smart network engine 310 operates in two modes: an identification mode and an action mode. When operating in identification mode, the smart network engine 310 gathers information about state changes in network components by collecting tags generated by network components or applications as well as information about changes in the network (e.g. network events), in order to learn relationships between tags and events. When operating in action mode, the smart network management system 300 can monitor tags generated by network components in real-time, and apply the learned relationships between tags and events to take actions to proactively manage the network quality of service (QoS) and quality of experience (QoE). In some examples, a correlation engine 400 may be used to learn the relationships between tags and events in the distributed computer network.

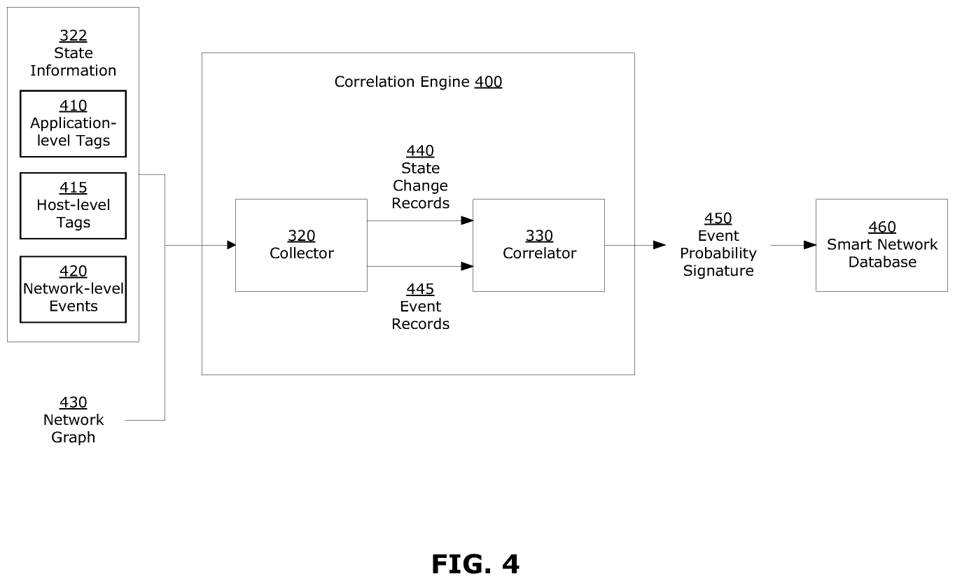

FIG. 4 is a block diagram of an example correlation engine 400 of the smart network engine 310, in accordance with the present disclosure. In some examples, the correlation engine 400 receives inputs of state information 322 and information about the relationship between components in the network configuration, for example, a network graph 430, and outputs an event probability signature 450. In some examples, the event probability signature 450 is a learned relationship between tags and events in the distributed computer network.

In some examples, the state information 322 may include one or more application-level tags 410 representing an application state change, for example, a change in the state of an application 132 running on a host node in the distributed computer network. For example, an application-level tag 410 may be information that is obtained from the application 132, (e.g. the application type, deployment information, configuration, etc.) or representing the state of the application (e.g. response/request, number of repetitions, Start/End time, direction, etc.) while the application is performing some process. In other words, any function logic that an application 132 is running can be used to generate an associated application-level tag 410. Examples of application-level tags may include signals generated by applications when executing certain functions, such as multiget (e.g. when a database application is fetching data from multiple machines at the same time), or allreduce (when a distributed machine learning application is gathering data from multiple distributed nodes), among others.

In some examples, the state information 322 may also include one or more host-level tags 415 representing a change in the state of the host in the distributed computer network. For example, a host-level tag 415 may be information related to the state of the hardware resources while an application is running on a host, for example, application usage (e.g. CPU cycles used, Disk I/O Total disk I/O, Memory I/O and Total memory I/O etc.), socket level (e.g. Inter flow gap, start/end time, packet drops, congestion events, Tx rate, flow completion time (FCT), flow size, congestion window change, message buffer size, etc.), or network activity (e.g. data transfer in to a host or data transfer out of a port, etc.), among others. An example of a host-level tag 415 may include information generated by the host-level congestion window (CWND) to indicate how much data flow is intended to be sent next.

In some examples, the state information 322 may also include one or more network-level events 420 related to problems in the flow of data through the network as experienced by the application 132. Examples of network-level events may be bursts, packet drops, queue size exceeding a threshold, load, among others.

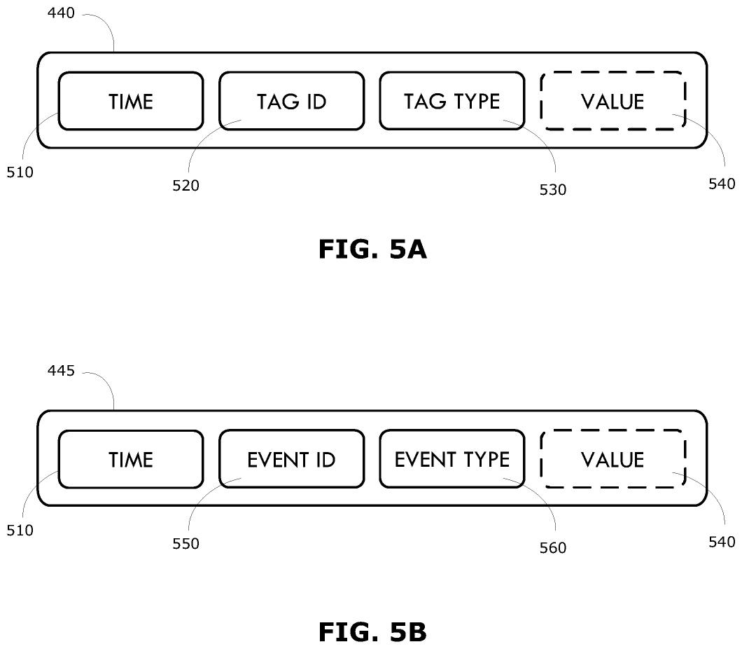

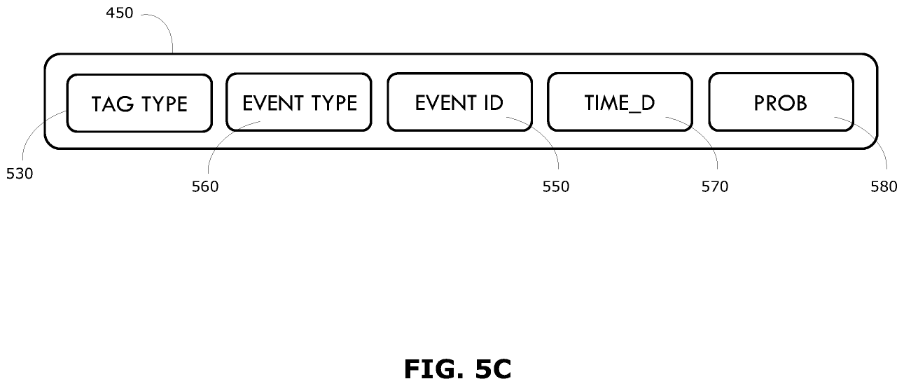

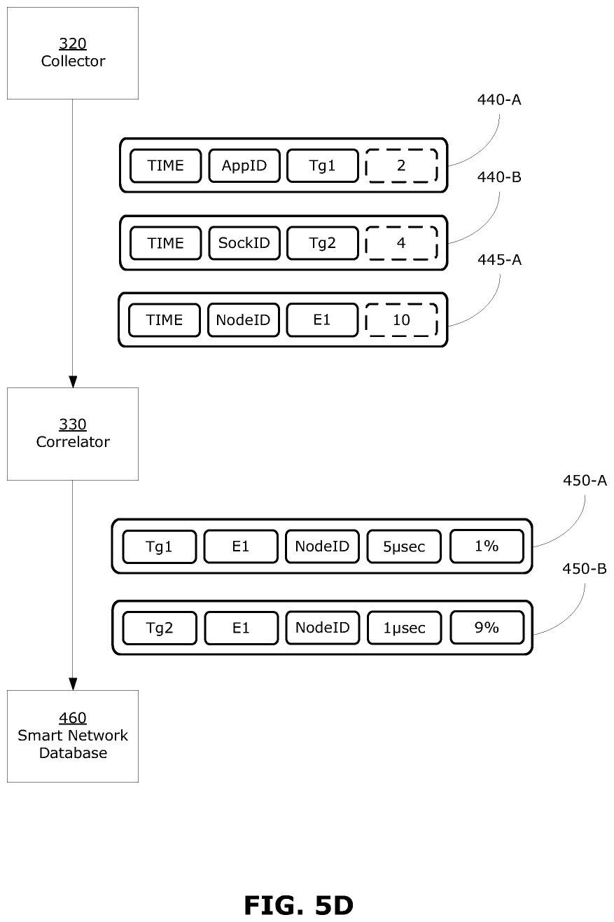

In some examples, state information 322 and the network graph 430 are received by a collector 320. In some examples, the collector 320 may format the application-level tags 410, the host-level tags 415 and network-level events 420 into a specific format, as described with reference to FIGS. 5A and 5B.

FIG. 5A is a schematic diagram illustrating an example state change record 440 format, in accordance with the present disclosure. In some examples, the collector 320 takes the information contained within tags generated by applications 132 or endpoints in the distributed computer network and may assemble the information into a state change record 440, for example, following the format {time, tag ID, tag type, value} based on a set of predefined rules. In some examples, the format provides a generic, uniform representation for state change records 440 associated with a wide variety of applications. In some examples, time 510, tag ID 520 and tag type 530 are required entries in the state change record 440 and value 540 is optional. In some examples, time 510 may represent a timestamp indicating when the tag occurred. In some examples, tag ID 520 may represent a local identifier that indicates a location (e.g. at a host node) where the tag occurred in the network, for example, a tag ID 520 may be an AppID, JobID, FlowID, 5-tuple, SockID, among others. In some examples, tag type 530 may be a generic entry representing the type of tag that has been formatted, for example, “S2C” (e.g. for a distributed machine learning application), “MG” for a multiget request (e.g. for the Memcached Application), among others. Optionally, value 540 may specify a parameter that is relevant to the tag type or associated state change, for example, a state change record 440 associated with a multiget request may include a value 540 that specifies a size associated with the multiget request. In some embodiments, for example, including an optional value 540 in the state change record 440 provides additional information that can be used to determine a relationship between tags and events, and improve predictive capabilities of the smart network management system 300.

FIG. 5B is a schematic diagram illustrating an example event record 445 format, in accordance with the present disclosure. In some examples, when a network event occurs in the network, the collector 320 may assemble information associated with the network event into an event record 445, for example, following the format {time, event ID, event type, value} based on a set of predefined rules. In some examples, the format provides a generic, uniform representation for event records 445 associated with a wide range of network events. In some examples, time 510, event ID 550 and event type 560 are required entries in the event record 445 and value 540 is optional. In some examples, time 510 may represent a timestamp indicating when the event occurred. In some examples, event ID 550 may represent a local identifier that indicates a location where the event occurred in the network, for example, an event ID 550 may be a nodeID for a specified network node (e.g. a switch 106). In some examples, event type 560 may be a generic entry representing the type of event that has been formatted, for example, “e1” or “e2”. Optionally, value 540 may specify a parameter that is relevant to the event type. In some embodiments, for example, including an optional value 540 in the event record 445 provides additional information that can be used to determine a relationship between tags and events, and improve predictive capabilities of the smart network management system 300.

Returning to FIG. 4, in some examples, the correlator 330 may input the plurality of state change records 440 and event records 445 and generate one or more event probability signatures 450. In some examples, the event probability signature 450 may be a tuple following a specific format, as described with reference to FIG. 5C.

FIG. 5C is a schematic diagram illustrating an example event probability signature 450 format, in accordance with the present disclosure. In some examples, the correlator 330 takes the information contained within state change records 440 and event records 445 and may assemble the information into an event probability signature 450, for example, a tuple with the format {tag type, event type, eventID, time duration, probability} based on a set of predefined rules. In some examples, tag type 530 and event type 560 may indicate the type of state change and the type of event that has been paired in the probability signature 450 format, for example, a first state change having a tag type 530 of “Tg1” and a first event having an event type 560 of “E1”. In some examples, event ID 550 may represent a local identifier that indicates a network location where the event specified by event type 560 occurred in the network, for example, a specified network node. In some examples, time_d 570 may represent a pre-determined period of time following a specified tag type 530 occurring, during which a predicted corresponding specified event type 560 may occur. In some examples, prob 580 may describe the likelihood of the a specified event type 560 occurring, for example, a probability of the specified event type 560 occurring at a specified event ID 550 within a pre-determined time duration 570 based on the occurrence of specified tag type 530.

Returning to FIG. 4, in some embodiments, for example, the correlator 330 may be a machine learning model. In other embodiments, for example, the correlator 330 may correlate state change records 440 and event records 445 using a rule-based statistical model, or in other embodiments another method may be used. In an embodiment, for example, the correlator 330 may group the state change records 440 and event records 445 based on the tag ID 520 and the event ID 550, as well as any previously learned relationship information, for example, using a temporal mining algorithm. An example temporal mining algorithm is described in: Wang, Ting, et al., “Learning, indexing, and diagnosing network faults,” Proceedings of the 15th ACM SIGKDD international conference on Knowledge discovery and data mining, 2009, the entirety of which is hereby incorporated by reference. Another example temporal mining algorithm is described in: Wang, Ting, et al., “Spatio-temporal patterns in network events,” Proceedings of the 6th International Conference, 2010, the entirety of which is hereby incorporated by reference. In some examples, the correlator 330 may then cluster the groups of state change records 440 and event records 445 based on a position within a certain time window. In some examples, the correlator 330 may then estimate probabilities 580 associated with pairs of state change records 440 and event records 445 in each cluster, based on the elements in each cluster. In some examples, in estimating the probabilities 580, the correlator 330 may identify which tag types 530 in the plurality of state change records 440 are more likely to be correlated with a specified event type 560. In other embodiments, for example, another correlation method may be used to generate event probability signatures 450. In some examples, the correlator 330 outputs event probability signatures 450 which may then be stored within a local smart network database 460 on an end host.

In some examples, the smart network engine 310 iteratively updates event probability signatures 450 to reflect changing network conditions. For example, correlation probabilities 580 C may be adjusted to reflect current network conditions using a moving average estimate of the probabilities 580 based on a controllable parameter a. In some examples, the parameter a may be tuned based on the current state of the network or based on a specific use case using the following equation, where a higher value of a corresponds to greater importance being placed on more recent probability values C and where a lower value of a corresponds to greater importance being placed on older probability values C_{old}.

C_{new}=αC+(1−α)C_{old}

FIG. 5D is a block diagram illustrating example state change records 440 and an example event record 445 as generated by the collector 320, as well as example event probability signatures 450 as generated by the correlator 330, in accordance with the present disclosure. For example, state change record 440-A describes a tag generated by an application at a given time, corresponding to an application with a given application ID, the tag having a tag type 530 of “Tg1” and having a value equal to “2”. In another example, state change record 440-B describes a tag generated by a host at a given time, corresponding to a socket ID identifying, for example, a socket at which a TCP/IP request is associated, the tag having a tag type 530 of “Tg2” and having a value equal to “4”. In another example, event record 445-A describes an event occurring in the network at a given time, corresponding to a network node ID identifying, for example, the switch or router at which the event occurred, the event having an event type “E1” and having a value equal to “10”.

In another example, an event probability signature 450-A describes the relationship between the tag type “Tg1” and the event type “E1”. For example, event probability signature 450-A predicts a 1% probability of event “E1” occurring at the network location specified by a “NodeID” within a 5 μsec time duration after tag type “Tg1” has occurred. In another example, an event probability signature 450-B describes the relationship between tag type “Tg2” and event type “E1”. In another example, event probability signature 450-B predicts a 9% probability of event type “E1” occurring at the network location specified by a “NodeID” within a 1 μsec time duration after tag type “Tg2” has occurred. Both event probability signatures 450-A and 450-B may be stored within a local smart network database 460.

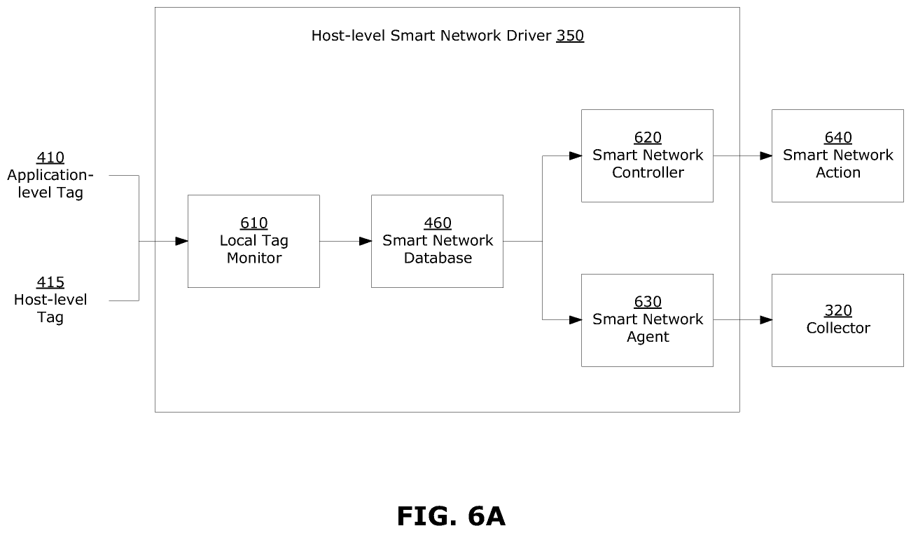

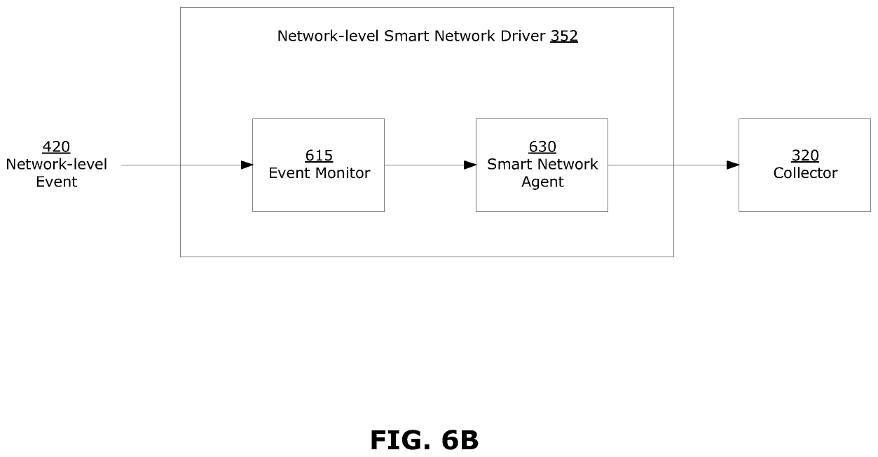

In some examples, to enable each node in the smart network management system 300 to interact with the smart network engine 310, software drivers such as the host-level smart network driver 350 and the network-level smart network driver 352 (e.g. 352a-n) may be installed on each node and configured to interface with the smart network engine 310, as described with reference to FIGS. 6A and 6B.

FIG. 6A is a block diagram of an example host-level smart network driver 350, in accordance with the present disclosure. In some examples, a host-level smart network driver 350 may run on a host node (e.g. server 110). In some examples, a local tag monitor 610 may monitor application-level tags 410 generated by applications 132 running on the host, or host-level tags 415 generated by the host to obtain a state change record 440 that indicates a type of state change (e.g. tag type 530) that has occurred at one of the host nodes and a timestamp 510 of the state change. In some examples, in monitoring the application-level tags 410 and host-level tags 415, the local tag monitor 610 may format any application-level tags 410 and host-level tags 415 into state change records 440. In some examples, the local tag monitor 610 may cross-reference any of the obtained state change records 440 with event probability signature 450 entries stored within a local smart network database 460, and in doing so, compare the type of state change (e.g. tag type 530) indicated in the state change record 440 with the types of state changes specified in the plurality of event probability signatures 450 to select a matching event probability signature 450. As previously described with respect to FIG. 5C, event probability signatures 450 indicate a respective probability that a specified event type 560 will occur at a specified network node given a specified type of state change at one of the hosts.

In some examples, if a matching event probability signature 450 is selected for a state change record 440, the host-level smart network driver 350 may provide the matching event probability signature 450 to a smart network controller 620. In some examples, the smart network controller 620 uses the event probability signature 450 to produce a smart network action 640. In some examples, the smart network action 640 may include generating rules and policies 342 for proactive network management, for example, in the form of a rule, an action or an expiration. In some examples, the expiration specifies a duration for which a rule or a policy 342 defining the smart network action 640 should be active in the network.

In some examples, the smart network engine 310 may recognize the occurrence of a specific tag type 530 indicated in the selected matching event probability signature 450, and based on the respective probability 580 that a future event of the specified event type 560 will occur at the specified network node (e.g. indicated by the event ID 550) indicated in the selected matching event probability signature 450, the smart network controller 620 that is configured to control one or more of the network switches 106 or the servers 110 may execute a smart network action 640, for example, to proactively improve network performance. In some examples, the smart network controller 620 may generate and install a rule, an action or a policy 342 and set it to delete after the expiration time. In the absence of an event probability signature, the smart network controller 620 may apply default actions. In some examples, the smart network controller 620 may be use case specific and can be implemented using existing SDN controllers or other technologies. For example, to handle packet drops in the network, a smart network controller 620 can implement a smart network action 640 to rate limit sender NICs upon seeing a specified tag type 530 using a native Linux traffic control utility such as TC. Similarly, the smart network controller 620 could install a rule and action in the switch dataplane to reroute traffic associated with a specified tag type 530, for example, using OpenvSwitch (OVS) with Programming Protocol-independent Packet Processors (P4). In another example, the smart network controller 620 may proactively update the forwarding tables to reroute flows based on the event probability signature 450 to avoid congestion in the network.

In some examples, the host-level smart network driver 350 is configured to share information about state change records 440 with the smart network engine 310 via a software agent, for example, a smart network agent 630. In some examples, if the local tag monitor 610 is unable to select a matching event probability signature 450 for an identified state change record 440, the host-level smart network driver 350 may engage the smart network agent 630 to interface with the collector 320, to input the given state change record 440 to the correlator 330 in order to generate a matching event probability signature 450. Once a matching event probability signature has been generated by the correlator 330, the smart network agent 630 may update the local smart network database 460 and other smart network databases 460 stored on other hosts in the distributed computer network, with a new entry reflecting the new event probability signature 450. In this way, the smart network management system 300 can seamlessly transition from operating in action mode to identification mode, and vice versa, in order to continuously feed new information about state changes at the hosts to the smart network engine 310. In some examples, by continuously generating new event probability signatures 450 and distributing these new event probability signatures 450 to local smart network databases 460 stored on hosts throughout the distributed computer network, the smart network management system 300 may continuously improve its ability to proactively mitigate future network events. In this way, the next time that the local tag monitor 610 encounters a similar state change record 440, a matching event probability signature 450 will exist in the local smart network database to be selected and the host-level smart network driver 350 can engage the smart network controller 620 accordingly, to proactively manage the network.

FIG. 6B is a block diagram of an example network-level smart network driver 352, in accordance with the present disclosure. In some examples, a network-level smart network driver 352 may run on a network node such as a switch 106 and may be configured to share information about network level events 420 with the smart network engine 310 engine via a smart network agent 630. In some examples, an event monitor 615 may monitor for network-level events 420 occurring at the network node. In some examples, when a network-level event 420 is identified, a smart network agent 630 may be engaged to interface with the collector 320 to initiate identification mode, and input the given network-level event 420 to the collector 320 in order to create an corresponding new event record 445. In some examples, the new event record 445 may be input to the correlator 330 to generate new event probability signatures 450. In this way, the smart network management system 300 can seamlessly transition from operating in action mode to identification mode, and vice versa, in order to continuously feed new information about state changes in the network to the smart network engine 310. In some examples, by continuously generating new event probability signatures 450 and distributing these new event probability signatures 450 to local smart network databases 460 stored on hosts throughout the distributed computer network, the smart network management system 300 may continuously improve its ability to proactively mitigate future network events.

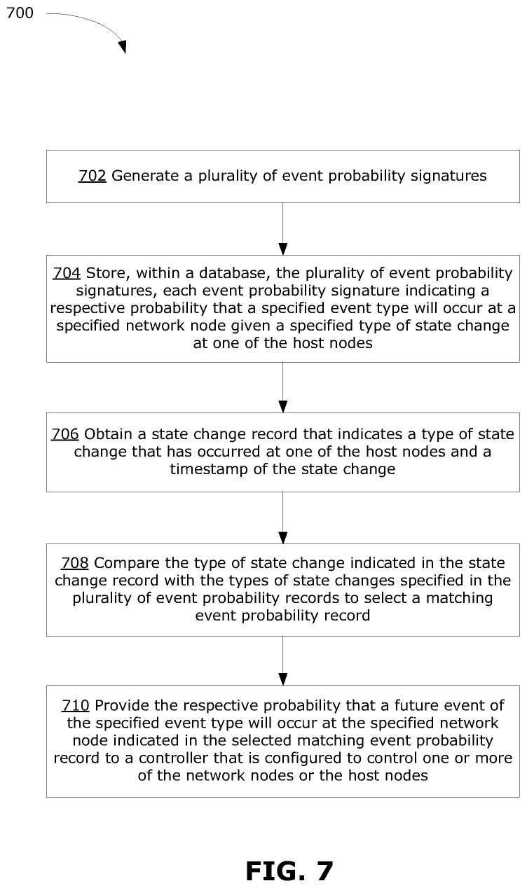

FIG. 7 is a flowchart illustrating an example method 700 for managing a distributed computer network that comprises a plurality of host nodes (e.g. servers 110) that each host one or more applications 132, and a network 105 that interconnects the host nodes and comprises a plurality of network nodes (e.g. switches 106), in accordance with examples of the present disclosure. The method 700 may be performed by a host node within the smart network management system 300. The method 700 represents operations performed by the host-level smart network driver 350 in FIG. 6A. For example, a processing device 114 of a server 110 may execute computer readable instructions 130 (which may be stored in a memory 128) to cause the server 110 to perform the method 700.

The method 700 starts at step 702, in which a plurality of event probability signatures 450 are generated. In some examples, a plurality of state change records 440 representing a plurality of state changes occurring at one or more of the host nodes are obtained. In some examples, a plurality of event records 445 representing a plurality of network events occurring at one or more of the network nodes are also obtained. In some examples, the plurality of state change records 440 and the plurality of event records 445 are correlated to generate the one or more event probability signatures 450, the one or more event probability signatures 450 describing a learned relationship between one or more state change types and respective event types.

The method 700 then proceeds to step 704. At step 704, a plurality of event probability signatures 450 are stored within a smart network database 460 on a host node. In some examples, each event probability signature 450 indicates a respective probability 580 that a specified event type 560 will occur at a specified network node (e.g. indicated by the event ID 550) given a specified type of state change (e.g. as indicated by the tag type 530) at one of the host nodes (e.g. as indicated by the tag ID 520) in the distributed computer network.

The method 700 then proceeds to step 706. At step 706, a state change record 440 is obtained that indicates a type of state change that has occurred at one of the host nodes and a timestamp 510 of the state change.

The method 700 then proceeds to step 708. At step 708, the type of state change indicated in the state change record 440 is compared with the types of state changes specified in the plurality of event probability signatures 450 to select a matching event probability signature 450.

The method 700 then proceeds to step 710. At step 710, based on the information in the matching event probability signature 450, the respective probability 580 that a future event of the specified event type will occur at the specified network node indicated in the selected matching event probability signature 450 is provided to a smart network controller 620 that is configured to control one or more of the network nodes or the host nodes.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for managing a distributed computer network that comprises a plurality of host nodes that each host one or more applications, and a network that interconnects the host nodes and comprises a plurality of network nodes for routing data within the network, comprising:
storing, within a database, a plurality of event probability signatures, each event probability signature indicating a respective probability that a specified event type will occur at a specified network node given a specified type of state change at one of the host nodes;
obtaining a state change record that indicates a type of state change that has occurred at one of the host nodes and a timestamp of the state change;
comparing the type of state change indicated in the state change record with the types of state changes specified in the plurality of event probability signatures to select a matching event probability signature; and
providing the respective probability that a future event of the specified event type will occur at the specified network node indicated in the selected matching event probability signature to a controller that is configured to control one or more of the network nodes or the host nodes.

2. The method of claim 1, further comprising generating the plurality of event probability signatures by:
obtaining a plurality of state change records representing a plurality of state changes occurring at one or more of the host nodes;
obtaining a plurality of event records representing a plurality of network events occurring at one or more of the network nodes; and
correlating the plurality of state change records and the plurality of event records to generate the one or more event probability signatures, the one or more event probability signatures describing a learned relationship between one or more state change types and respective event types.

3. The method of claim 2, wherein correlating the plurality of state change records and the plurality of event records comprises:
grouping the plurality of state change records and the plurality of event records into one or more groups based a state change location and an event location as well as any previously learned relationship information, using a temporal mining algorithm;
clustering the groups of state change records and event records based on a timestamp of each state change record and a timestamp of each event record in each group, the timestamp of each state change record and the timestamp of each event record indicating a position of a respective state change type and a position of a respective event type within a certain time window; and
estimating, for each cluster, one or more probabilities that a specified event type will occur at a specified network node given a specified type of state change at one of the host nodes, based on one or more elements in each cluster.

4. The method of claim 3, wherein correlating the plurality of state change records and the plurality of event records is performed by a machine learning model that has been trained to identify the respective probability that a specified event type will occur at a specified network node given a specified type of state change at one of the host nodes.

5. The method of claim 3, wherein correlating the plurality of state change records and the plurality of event records is performed by a rule based statistical model that has been trained to identify the respective probability that a specified event type will occur at a specified network node given a specified type of state change at one of the host nodes.

6. The method of claim 2, wherein obtaining a plurality of state change records comprises:
obtaining information describing one or more state changes at one or more specified host nodes; and
formatting the state change information for each state change to generate one or more state change records, each state change record comprising:
a timestamp that indicates when the state change occurred at one of the specified host nodes;
a location identifier that indicates the one of the specified host nodes where the state change occurred; and
a state change type identifying the type of the state change that occurred at the one of the specified host nodes.

7. The method of claim 6, wherein the state change record further comprises a value that indicates a property associated with the state change type.

8. The method of claim 6, wherein the state change record can be an application-level state change record or a host-level state change record.

9. The method of claim 8, wherein the application level state change record identifies one of:
an application type;
an application deployment;
an application configuration;
a state of an application response/request;
a number of repetitions;
an application start and end time; or
a direction.

10. The method of claim 8, wherein the host-level state change record identifies one of:
a state of hardware resources while an application is running on a host;
a socket level;
a state of data transfer into a host; or
a state of data transfer out a port.

11. The method of claim 1, wherein obtaining a plurality of event records comprises:
receiving information about one or more network events occurring at one or more specified network nodes; and
formatting the network event information for each network event to generate one or more event records, each event record comprising:
a timestamp that indicates when the network event occurred at one of the specified network nodes;
a location identifier that indicates the one of the specified network nodes where the network event occurred; and
an event type identifying the type of the network event that occurred at the one of the specified network nodes.

12. The method of claim 11, wherein the event record further comprises a value that indicates a property associated with the event type.

13. A method for managing a distributed computer network that comprises a plurality of host nodes that each host one or more applications, and a network that interconnects the host nodes and comprises a plurality of network nodes, comprising:
generating a plurality of event probability signatures, each event probability signature indicating a respective probability that a specified event type will occur at a specified network node given a specified type of state change at one of the host nodes, the plurality of event probability signatures being generated by:
obtaining a plurality of state change records representing a plurality of state changes occurring at one or more of the host nodes;
obtaining a plurality of event records representing a plurality of network events occurring at one or more of the network nodes; and
correlating the plurality of state change records and the plurality of event records to generate one or more event probability signatures, the one or more event probability signatures describing a learned relationship between one or more state change types and respective event types.

14. The method of claim 13, wherein each event probability signature comprises:
a state change type identifying a specified type of the respective state change that occurred at a specified host node of the one or more host nodes;
an event type identifying a specified type of the respective network event that occurred at a specified network node of the one or more network nodes;
a location identifier that indicates the one of the specified network nodes where the respective network event occurred;
a time delay indicating a pre-determined period of time following the specified state change type occurring, during which a predicted event corresponding to the specified event type may occur; and
a probability that the specified event type will occur at the specified network node of the one or more network nodes within the pre-determined period of time following the occurrence of the specified state change type, given the specified state change type occurs at the specified host node of the one or more host nodes.

15. The method of claim 1, wherein executing a smart network action comprises:
generating a rule or policy corresponding to a specified state change type, based on the event probability signature;
installing the rule or policy at one of the host nodes or one of the network nodes;
setting an expiration time defining a length of time for which the rule or policy installed at the one of the host nodes or the one of the network nodes can be executed;
performing the action specified in the rule or policy installed at the one of the host nodes or the one of the network nodes if a state change type matching the specified state change type occurs at the one of the host nodes or the one of the network nodes; and
deleting the rule or policy from the one of the host nodes or the one of the network nodes once the expiration time has been reached.

16. A system for managing a distributed computer network, comprising:
a plurality of host nodes that each host one or more applications;
a network that interconnects the host nodes and comprises a plurality of network nodes;
a processing device on one of the host nodes; and
a memory in communication with the processing device, the memory storing machine-executable instructions which, when executed by the processing device, cause the system to:
store, within a database, a plurality of event probability signatures, each event probability signature indicating a respective probability that a specified event type will occur at a specified network node given a specified type of state change at one of the host nodes
obtain a state change record that indicates a type of state change that has occurred at one of the host nodes and a timestamp of the state change;
compare the type of state change indicated in the state change record with the types of state changes specified in the plurality of event probability signatures to select a matching event probability signature; and
provide the respective probability that a future event of the specified event type will occur at the specified network node indicated in the selected matching event probability signature to a controller that is configured to control one or more of the network nodes or the host nodes.

17. The system of claim 16, wherein the machine-executable instructions, when executed by the one or more processing devices, further cause the system to:
generate the plurality of event probability signatures by:
obtaining a plurality of state change records representing a plurality of state changes occurring at one or more of the host nodes;
obtaining a plurality of event records representing a plurality of network events occurring at one or more of the network nodes; and
correlating the plurality of state change records and the plurality of event records to generate the one or more event probability signatures, the one or more event probability signatures describing a learned relationship between one or more state change types and respective event types.

18. The system of claim 17, wherein in correlating the plurality of state change records and the plurality of event records, the machine-executable instructions, when executed by the one or more processing devices, further cause the system to:
group the plurality of state change records and the plurality of event records into one or more groups based a state change location and an event location as well as any previously learned relationship information, using a temporal mining algorithm;
cluster the groups of state change records and event records based on a timestamp of each state change record and a timestamp of each event record in each group, the timestamp of each state change record and the timestamp of each event record indicating a position of a respective state change type and a position of a respective event type within a certain time window; and
estimate, for each cluster, one or more probabilities that a specified event type will occur at a specified network node given a specified type of state change at one of the host nodes, based on one or more elements in each cluster.

19. The system of claim 18, wherein correlating the plurality of state change records and the plurality of event records is performed by a machine learning model that has been trained to identify the respective probability that a specified event type will occur at a specified network node given a specified type of state change at one of the host nodes.

20. The system of claim 18, wherein correlating the plurality of state change records and the plurality of event records is performed by a rule based statistical model that has been trained to identify the respective probability that a specified event type will occur at a specified network node given a specified type of state change at one of the host nodes.
